(19) United States
(12) Patent Application Publication
(10) Pub. No.: US 2007/0241594 A1
(43) Pub. Date: Oct. 18, 2007

(54) ANTI-WHIPLASH SAFETY APPARATUS

(76) Inventor: Carl Taylor, Mooresville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/697,843

(22) Filed: Apr. 9, 2007

Related U.S. Application Data
(60) Provisional application No. 60/792,043, filed on Apr. 14, 2006.

(51) Int. Cl. B60N 2/42

(52) U.S. Cl. 297/216.12

(57) ABSTRACT

An anti-whiplash device attaches to existing vehicle head restraints and provides an elastic pocket or cavity in which impact absorbing pads are placed. The pads may be pre-sized so that the thickness of the additional impact absorbing material can be easily determined. The use of the impact absorbing pads reduces the distance from the head of a vehicle driver or passenger to the head restraint while in a normal driving or riding position so that the driver's or passenger's head does not travel a significant distance before being cushioned by the head restraint in the event of an accident.

### REFERENCE TO RELATED APPLICATION

This application claims the benefit of U.S. Provisional Application Ser. No. 60/792,043, filed Apr. 14, 2006, which is hereby incorporated by reference in its entirety.

### BACKGROUND

Many injuries from automobile or other vehicle accidents are related to neck whiplash suffered by drivers and passengers due to insufficient head and neck support. It is the intention of seatback head rests or restraints to prevent or alleviate these injuries, but poor head restraint design and individual driving habits and positions often render these standard-feature devices ineffective.

This disclosure will describe a supplemental head and neck restraint device that works in conjunction with a standard vehicle head restraint and is configurable to provide increased anti-whiplash protection for individuals regardless of their normal driving or riding position.

### SUMMARY

In accordance with an aspect of the disclosure, there is provided an elastic enclosure that is attached to an existing vehicle head restraint. Impact absorbing material is placed inside the enclosure to reduce the distance between the head of a driver or passenger of the vehicle and the head restraint when the driver or passenger is in a normal driving or riding position. The amount of the impact absorbing material is chosen based on the normal driving or riding position of the driver or passenger.

Further objects, embodiments, forms, benefits, aspects, features and advantages of the present disclosure may be obtained from the description, drawings, and claims provided herein.

### DESCRIPTION OF THE DRAWING

FIG. 1 is a side elevational diagrammatic view of the interior of a motor vehicle illustrating a principle of the disclosure.

FIG. 2 is a side elevational cross-sectional view of a supplemental vehicle head restraint apparatus in accordance with an aspect of the disclosure.

FIG. 3 is a side elevational cross-sectional view of a supplemental vehicle head restraint apparatus in accordance with another aspect of the disclosure.

FIG. 4 is a side elevational cross-sectional view of a supplemental vehicle head restraint apparatus in accordance with a further aspect of the disclosure.

FIG. 5 is a side elevational cross-sectional view of a supplemental vehicle head restraint apparatus in accordance with an additional aspect of the disclosure.

### DETAILED DESCRIPTION

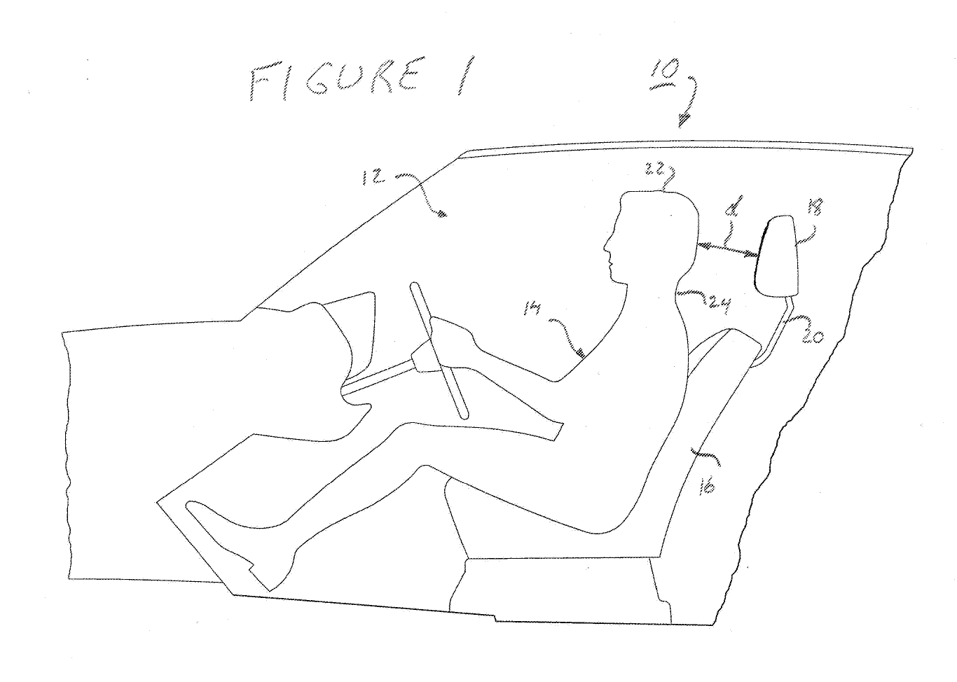

FIG. 1 illustrates a portion of a vehicle 10 and in particular, the interior 12 of vehicle 10. A driver 14 is shown seated in a vehicle seat 16 having a standard or factory provided head rest or restraint 18 mounted to seat 16 by way of extension posts or brackets 20. Driver 14 is illustratively shown as being in a “normal” driving or riding position, i.e., normal for driver 14. It can be seen that the head 22 and neck 24 of driver 14 is located a distance d away from head restraint 18. In an accident such as a rear-end collision, the head 22 and neck 24 of driver 14 will travel a significant distance, and therefore experience a significant amount of whiplash force, prior to head 22 and neck 24 contacting restraint 18. The existing or factory-installed head restraint 18 therefore provides insufficient protection for the head 22 and neck 24 of driver 14, or a similarly seated passenger (not shown), in the event of an accident.

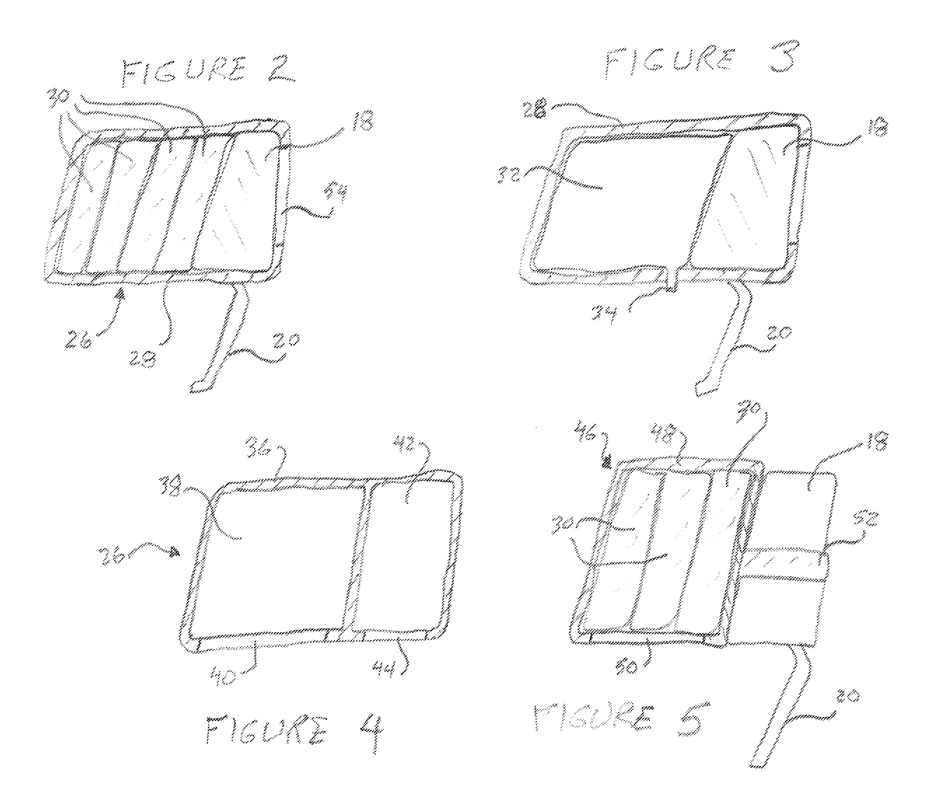

In accordance with an aspect of the disclosure, FIG. 2 illustrates, in a cross-sectional view, an anti-whiplash safety apparatus 26 that cooperates with existing factory-installed head rests or restraints, such as head restraint 18 as shown in FIG. 1. In FIG. 2, apparatus or device 26 is shown as comprising a stretchable or elastic cover 28, designed and dimensioned to encase one or more impact-absorbent members or pads 30. Pads 30 may be made of dense foam or other similar impact absorbing material that will absorb the energy imparted by head 22 and neck 24 of driver 14 in an accident. Pads 30 are illustratively shown as being pre-sized and made in relatively thin sheets or panels, e.g., about 1 inch thick, so that the particular number of pads 30 that are needed to effectively bridge distance d between the head 22 and neck 24 of driver 14 can be chosen and specifically placed inside cover 28 to effectively result in a custom-fitted head restraint for driver 14, or any other driver or passenger in vehicle 10. Pads 30 may also be provided in various other pre-sized thicknesses so that fewer numbers of pads may be required to achieve the desired dimensioning or “fit” of apparatus 26. Alternatively, as shown in FIG. 3, an inflatable bladder 32 having an air valve 34, could be used in place of, or in addition to, pads 30 and inflated to the degree necessary to provide a custom fit for apparatus 26. In this way, the head 22 or neck 24 of a driver 14, for example, will not move or travel very far before the head or neck is cushioned by apparatus 26, thereby reducing the amount of whiplash force imparted to driver 14 in the event of an accident.

In one example, cover 28 is designed to elastically fit over existing head restraint 18, or any other type of factory-installed or existing head restraint. To accomplish this, cover 28 may be made sufficiently large and elastic enough to hold the desired number of pads 30 while still enabling cover 28 to be stretched over head restraint 18. Cover 28 may be made of one large compartment or cavity that holds pads 40 as well as stretching over restraint 18, as shown in FIG. 2. Apparatus 26 may also be made with a cover 36 that has separate “pockets” or compartments, for example, as shown in FIG. 4, a compartment 38 that holds pads 30, which are inserted via an opening 40, and a compartment 42 that is designed to stretch over head restraint 18 via opening 44.

In another example, as can be seen in the partial cross-sectional view of FIG. 5, an anti-whiplash apparatus 46 may be designed with a cover 48 having only a single compartment with an opening 50 for inserting pads 30. Cover 48 is then fitted with one or more straps or bands 52, for example, that are fashioned and attached to cover 48 so that they may fit or be stretched around head restraint 18. Straps or bands 52 can be made of an elastic material that stretches around headrest 18, for example, or they can be made to fit by way of buckles, clasps, hooks, or any similar means of attachment. The manner in which cover 28 fits over headrest 18 in FIG. 2, or the manner in which covers 28 and 48 are made to accommodate pads 30, e.g., with zippers, slit-type openings (such as opening 54 shown in FIG. 2), releasable hook and loop closures (such as Velcro® fasteners) is not limited and is contemplated to encompass any design that accomplishes the desired result of securely maintaining pads 30 (with or without the addition of an inflatable bladder such as bladder 32) within covers 28 or 48 securely about headrest 18.

As one illustrative example, apparatus 26 or 46 is designed to accommodate driver or passenger positions that result in distance d being of the order of between 2 inches to 4 inches, with other dimensions or distances of course being contemplated. Covers 28 and 48 may be made of a variety of materials as well as being made available in different colors, to provide a decorative appearance, or to match or coordinate with the material and design of existing head restraint 18, or the color or design of the interior 12 of vehicle 10. Covers 28 and 48 are designed to be removable to accommodate washing or transfer between vehicles.

While the disclosure has been illustrated and described in detail in the drawings and foregoing description, the same is to be considered as illustrative and not restrictive in character, it being understood that only the preferred embodiments have been shown and described and that all changes, modifications and equivalents that come within the spirit of the disclosure provided herein are desired to be protected. The articles “a”, “an”, “said” and “the” are not limited to a singular element, and may include one or more such elements.

What is claimed is:

1. An anti-whiplash apparatus for a vehicle comprising:
an elastic member incorporating a cavity, said member coupled to a head restraint associated with a seat of said vehicle;
a quantity of impact absorbing material disposed within said cavity such that said material is contained within said cavity and extends forwardly from said head restraint, said quantity of material being selected such that the distance from the head of an occupant of said seat to said impact absorbing material is substantially less that the distance from the head of said occupant to said head restraint when said occupant is in a normal position in said seat.

2. The anti-whiplash device of claim 1, wherein said elastic member fits over said head restraint.

3. The anti-whiplash device of claim 1, wherein said elastic member is attached to said head restrain via a strap incorporating hook and loop fasteners.

4. The anti-whiplash device of claim 1, wherein said elastic member is attached to said head restraint via an elastic strap.

5. The anti-whiplash device of claim 1, wherein said elastic member is attached to said head restraint via a buckle.

6. The anti-whiplash device of claim 1, wherein said cavity of said elastic member accommodates a plurality of pre-sized impact absorbing panels.

7. The anti-whiplash device of claim 6, wherein said impact absorbing panels are provided having different sizes to enable the amount of impact absorbing material to be accurately determined.

8. The anti-whiplash device of claim 1, wherein said impact absorbing material comprises an electrometric foam.

9. The anti-whiplash device of claim 1, wherein said cavity of said elastic member incorporates an inflatable bladder.

10. An supplementary head restraint for a vehicle comprising:
an elastic member coupled to an existing head restraint of said vehicle, said elastic member comprising at least one cavity;
a quantity of impact absorbing material disposed within said cavity such that said impact absorbing material cooperates with said elastic member and said existing head restraint to increase the thickness of said head restraint.

11. The supplementary head restraint of claim 10, wherein said quantity of impact absorbing material is selected in accordance with the normal position of at least one occupant of said vehicle.

12. The supplementary head restraint of claim 10, wherein said elastic member comprises a first cavity for fitting over said existing head restraint and a second cavity for containing said impact absorbing material.

13. A method for reducing whiplash injuries as a result of vehicle accidents comprising:
providing an elastic member comprising at least one cavity;
coupling said elastic member to an existing head restraint of a vehicle;
placing a quantity of impact absorbing material within said at least one cavity such that the distance between the head of an occupant in said vehicle and said elastic member is significantly less than the distance between said head of said occupant and said existing head restraint when said occupant is in a normal riding position within said vehicle.

14. The method of claim 13, wherein said coupling of said elastic member comprises stretching said elastic member over said existing head restraint.

15. The method of claim 13, wherein said quantity of impact absorbing material is selected in accordance with said normal riding position of said occupant.
